(19) United States
(12) Patent Application Publication
(10) Pub. No.: US 2024/0335924 A1
(43) Pub. Date: Oct. 10, 2024

(54) Bit Change Connector

(71) Applicant: Stephen Gayton, Saint Clair Shores, MI (US)

(72) Inventor: Stephen Gayton, Saint Clair Shores, MI (US)

(21) Appl. No.: 18/350,853

(22) Filed: Jul. 12, 2023

Related U.S. Application Data
(60) Provisional application No. 63/495,208, filed on Apr. 10, 2023.

(51) Int. Cl. B25B 15/00; B23B 31/02

(52) U.S. Cl. CPC B25B 15/005; B23B 31/02; B23B 2231/0232

(57) ABSTRACT

A power tool drill/torque head bit connector is configured to be removably attached to a power tool and offers an alternative to changing drill/torque bits. The drill/torque head bit connector further comprises a chuck coupling portion and a bit securement portion for removably accommodating a drill bit or a torque bit. The chuck coupling portion and the bit securement portion are at opposing ends of the drill/torque head bit connector. The chuck coupling portion for coupling to the power tool. The chuck coupling portion having a male coupler configured to couple to a female coupler port of the power tool for receiving drive gear from the power tool. The bit securement portion configured to accommodate various bits and enables faster bit exchanges for drilling and/or torquing.

### CROSS-REFERENCE TO RELATED APPLICATION

The present application claims priority to, and the benefit of, U.S. Provisional Application No. 63/495,208, which was filed on Apr. 10, 2023, and is incorporated herein by reference in its entirety.

### FIELD OF THE INVENTION

The present invention relates generally to the field of bit change tools, for example, hand tools, electric powered tools, and drilling devices. More specifically, the present invention relates to a novel drill bit connector with different head attachments that can be interchanged to accommodate various types of fastener heads. The drill/torque bit includes magnetic properties within a male torx magnetic bit and a female torx opening to easily secure and interchange drill bits. The quick bit change connector enables user to tighten or loosen fasteners at various angles, even in tight spaces with a cordless drill. The quick bit change connector device saves time and effort on a worksite or job site when working with several different types of screws and fasteners. Accordingly, the present disclosure makes specific reference thereto. Nonetheless, it is to be appreciated that aspects of the present invention are also equally applicable to other like applications, devices, and methods of manufacture.

### BACKGROUND

By way of background, a drilling or torquing tool, air tool, power tool, impact wrench, pneumatic-powered tool, or electric powered tool is a type of tool driven to drill holes with bits or to turn fasteners. Electric power tools are types of power tools driven by electricity which is supplied by electrical cord/outlet or rechargeable battery. When using a power tool, individuals may have to constantly change and loosen the drill chuck to change drill heads, drill bits, and/or torque bits. Tightening and loosening screws and other fasteners in difficult or confined or hard-to-reach areas can be frustrating if the drill, and drill bit, cannot be applied at a specific angle. Interchanging different drill bit heads can be time consuming.

Individuals desire to carry a dedicated drilling and torquing device which is not cumbersome and laborious. Individuals desire a drill attachment that can quickly and easily attach to any drilling or torquing tool.

Drilling in narrow and hard-to-reach areas can be difficult when using power assisted drills and torque devices. Further, individuals desire an expediting device that can change drill bits to torque bits, or vice versa; and/or can change various sized bits to drill various sized holes and to torque different sized fasteners.

Therefore, there exists a long-felt need in the art for an improved drill bit or torque bit device that can be attached to any power tool. There is also a long-felt need in the art for a drill bit or a torque bit or torque bit changing device that can convert any tool to a quick bit change connector drilling device or quick bit change connector torquing device. Additionally, there is a long-felt need in the art for a drill head or torque head that can accommodate different drill bits. Moreover, there is a long-felt need in the art for a drill head or torque head that is easily attached to and removed from a tool. Further, there is a long-felt need in the art for a drill head design that can be used as an alternative to standard drill bits or torque bits that have to be removed from a drill chuck in order to make a change to the drill/torque bit or torque bit. Furthermore, there is a long-felt need in the art for an improved drill head or torque head that can be rotated at any speed using drive gear of the power tool. Finally, there is a long-felt need in the art for a quick-change drill bit or torque bit that is compatible with power tools and that can be used for drilling or torquing.

The subject matter disclosed and claimed herein, in one embodiment thereof, comprises a power tool drill/torque head or torque head. The power tool drill/torque head is configured to be removably attached to a power tool and offers an alternative to changing drill/torque bits. The drill/torque head further comprises a chuck coupling portion and a bit securement portion for removably accommodating a drill bit or a torque bit, the chuck coupling portion for coupling to the power tool, the chuck coupling portion having a male coupler configured to couple to a female coupler port of the power tool for receiving drive gear from the power tool. The bit securement portion configured to accommodate faster bit exchanges for drilling and/or torquing.

In this manner, the drill/torque head design of the present invention accomplishes all of the foregoing objectives and provides users with an improved drill/torque design that allows the user to drill/torque faster and to accommodate using any power tool. The drill/torque head bit connector comes in different designs and can be attached to power tools for receiving rotation motion from drive gear of the power tool to which the drill/torque head bit connector is attached.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a power tool drill/torque head. The power tool drill/torque head is configured to be removably attached to a power tool and further comprises a chuck engagement portion having a male chuck mount for removably accommodating a drill chuck, and a bit coupling portion for selectively coupling with a drill bit or a torque bit. The male chuck mount configured for coupling to a female port of the power tool. The male chuck mount, when secured to the female port of the power tool, receives power from the drive gear and is configured to rotate the drill/torque bit for performing drilling, torquing, assembling, and more.

In yet another embodiment, a detachable drill/torque bit head for a power tool is disclosed. The drill/torque head bit connector comprising a chuck engagement portion for securely mounting to a power tool. The chuck engagement portion having a male mount portion for secure coupling to a female port of the power tool for receiving drive force from the power tool, wherein a drill bit or a torque bit attached to bit coupling portion of the power tool is rotated using the rotatable shaft.

In yet another embodiment, the bit coupling portion having at least two different coupling configurations.

In yet another embodiment, the female port of the power tool receives the male chuck mount of the chuck engagement portion.

In yet another embodiment, a drill/torque bit is removably attached to the bit coupling portion and can be replaced with a different drill bit.

In yet another embodiment, the bit coupling portion can have a star shaped bit connection.

In yet another embodiment, the bit coupling portion can have a bit connector with a rounded shape including engagement edges.

In yet another embodiment, the bit coupling portion enables angled engagement of the bit coupling portion and an interchangeable drill/torque bit for driving by a power tool is disclosed.

In yet another embodiment, the tool includes a first male chuck coupling portion configured to be inserted into the female chuck port or receiver for driving the drill/torque head bit connector, the bit coupling portion having a second male coupling for removably receiving a drill bit or a torque bit, wherein the drill/torque bit receives drive force from the first male chuck coupling portion of the power tool.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a novel power drill quick-change bit connector of the present invention in accordance with the disclosed architecture;

FIG. 2 illustrates an enlarged view of a male portion bit end of the quick-change bit connector in accordance with the disclosed architecture;

FIG. 3 is an enlarged view of one potential embodiment of a torque bit in accordance with the disclosed architecture;

FIG. 4 illustrates a perspective view of another potential embodiment of a novel power drill quick-change bit connector of the present invention in accordance with the disclosed architecture;

FIG. 5 illustrates an enlarged view of another male portion bit end of the quick-change bit connector in accordance with the disclosed architecture;

FIG. 6 illustrates an elevational view of the another potential embodiment of the power quick-change bit connector in an angled drive orientation with an associated torque bit; and

FIG. 7 illustrates a pair of exemplary torque bits connected to the power drill quick-change bit connector.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved drill bit or torque bit device that can be attached to any power tool. There is also a long-felt need in the art for a drill bit or a torque bit or torque bit changing device that can convert any tool to a quick bit change connector drilling device or quick bit change connector torquing device. Additionally, there is a long-felt need in the art for a drill head or torque head that can accommodate different drill bits. Moreover, there is a long-felt need in the art for a drill head or torque head that is easily attached to and removed from a tool. Further, there is a long-felt need in the art for a drill head design that can be used as an alternative to standard drill bits or torque bits that have to be removed from a drill chuck in order to make a change to the drill/torque bit or torque bit. Furthermore, there is a long-felt need in the art for an improved drill head or torque head that can be rotated at any speed using drive gear of the power tool. Finally, there is a long-felt need in the art for a quick-change drill bit or torque bit that is compatible with power tools and that can be used for drilling or torquing.

The present invention, in one exemplary embodiment, is a novel detachable drill head bit connector for a power tool. The drill/torque head bit connector comprising a chuck coupling portion for securely coupling to a power tool, the chuck coupling portion including a first male portion for secure coupling to a female chuck or port of the power tool for receiving drive torque from the power tool. A drill bit or a torque bit selectively attached to a second male portion of the drill/torque head bit connector. The drill/torque head bit connector comes in different shapes, lengths, and sizes and can be attached to any power tool.

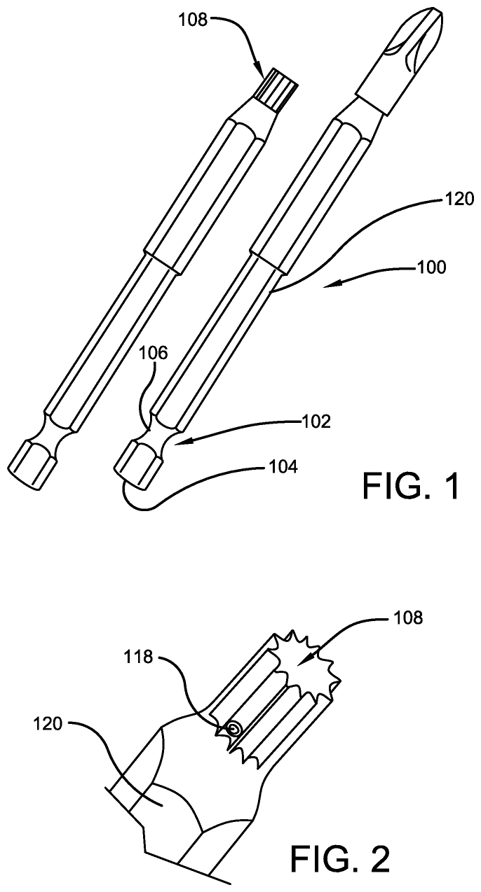

Referring initially to the drawings, FIG. 1 illustrates a perspective view of one potential embodiment of the novel drill/torque head bit connector 100 of the present invention in accordance with the disclosed architecture. The drill/torque head bit connector 100 is configured to attach to any power tool easily and quickly for enabling fast and easy drilling or torquing. Further, the drill/torque head bit connector 100 is configured to accommodate different drill bits that are interchangeably attached to the drill/torque head bit connector 100 allowing users to perform quick changes to drill/torque bits.

More specifically, the drill/torque head bit connector 100 is a compact tool for manipulation in small spaces and can be easily operated using any conventional power tool. The drill/torque head bit connector 100 has a chuck coupling portion 102 for coupling to a power tool and for receiving power from a drive gear of the power tool (not illustrated). The chuck coupling portion 102 has a plurality of planar surfaces 104 and a recessed neck 106 for securement in a female chuck retention mechanism (not illustrated) that helps in coupling the drill/torque head bit connector 100 to the power tool. It is to be appreciated that a drill chuck secures the chuck coupling portion 102 and includes jaws for holding the drill/torque head bit connector 100. The jaws can secure the drill/torque head bit connector 100 using the chuck coupling portion 102. The drill chuck is connected to the drill/torque head bit connector 100 wherein the connector 100 can be rotated using the gear drive of the power tool to which the drill/torque head bit connector 100 is mounted. The drill/torque head bit connector 100 is configured to rotate using the drive of the power tool to which the chuck coupling portion 102 is removably attached. Various drill bits and torque bits can be selectively connected to a second male portion 108 of the drill/torque head bit connector 100. The drill bits or torque bits 300 can include a female receiving end 302 for connecting with the second male portion 108. The female receiving end 302 and the second male portion 108 can include a star shape 108 (FIG. 2) or a rounded shape configuration (FIG. 5). The drill/torque head bit connector 100 can include round shanks or hex sided shanks 120.

FIG. 2 illustrates an enlarged view of the second male portion 108 having a star shape configuration. The second male portion 108 can include magnetic properties for securement to the female receiving end 302 of the torque bit. In addition, the second male portion 108 can include a spring biased ball bearing 118 compressible within the female receiving end 302 of the torque bit.

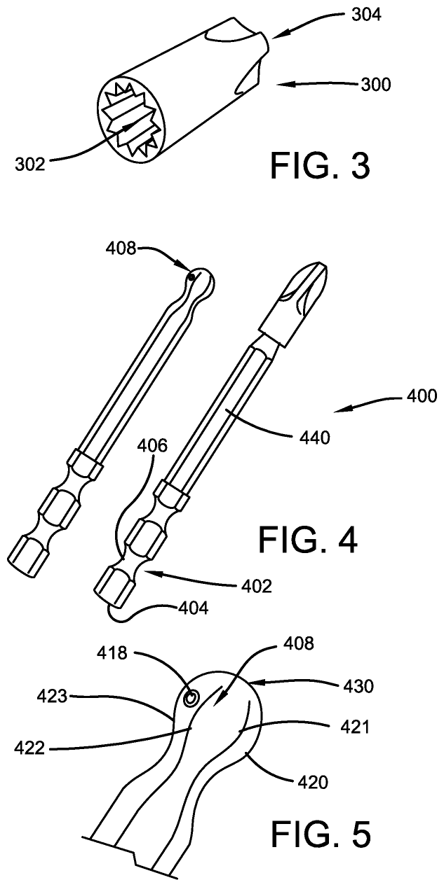

FIG. 3 illustrates a torque bit 300 having a female receiving end 302 including a star shape configuration for coupling with the second male portion 108. The torque bit 300 can include a variety of working ends for retention into a fastener. As illustrated, the torque bit having a Phillips working end 304 for fastening with a Phillips screw.

FIG. 4 illustrates a perspective view of another potential embodiment of a novel drill head 400 of the present invention in accordance with the disclosed architecture. The drill/torque head bit connector 400 is configured to attach to any power tool easily and quickly for enabling fast and easy drilling. Further, the drill/torque head bit connector 400 is configured to accommodate different drill bits that are interchangeably attached to the drill/torque head bit connector 400 allowing users to perform quick changes to drill/torque bits.

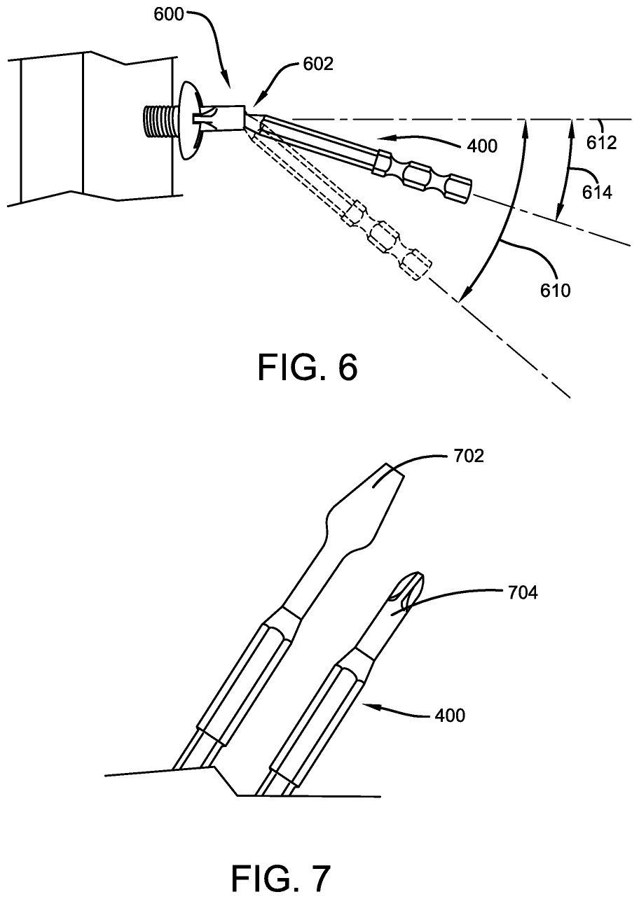

More specifically, the drill/torque head bit connector 400 enables quick changes to swap torque bits while maintaining a compact tool for manipulation. The head bit connector can be easily operated using any conventional power tool. The drill/torque head bit connector 400 has a chuck coupling portion 402 for coupling to a power tool and for receiving power from a drive gear of the power tool (not illustrated). The chuck coupling portion 402 has a plurality of planar surfaces 404 and a recessed neck 406 for securement in a female chuck retention mechanism (not illustrated) that helps in coupling the drill/torque head bit connector 400 to the power tool. It is to be appreciated that a drill chuck secures the chuck coupling portion 402 and includes jaws for holding the drill/torque head bit connector 400. The jaws can secure the drill/torque head bit connector 400 using the chuck coupling portion 402. The drill chuck is connected to the drill/torque head bit connector 400 wherein the connector 400 can be rotated using the gear drive of the power tool to which the drill/torque head bit connector 400 is mounted. The drill/torque head bit connector 400 is configured to rotate using the drive of the power tool to which the chuck coupling portion 402 is removably attached. Various drill bits and torque bits can be selectively connected to a second male portion 408 of the drill/torque head bit connector 400. It is to be appreciated that the drill bits or torque bits can include a female receiving end 602 (FIG. 6) for connecting with the second male portion 408. The female receiving end 602 and the second male portion 408 can include a rounded end configuration with a plurality of edges 420, 421, 422, 423 spaced around a periphery 430 of the rounded end. The drill/torque head bit connector 400 can include round shanks or hex sided shanks 440.

FIGS. 5 and 6 illustrate enlarged views of the second male portion 408 having a rounded shape configuration with a plurality of spaced apart edges 420, 421, 422, 423 around the periphery 430. The plurality of spaced apart edges are curvilinear along the rounded end. Although four edges 420, 421, 42, 423 are illustrated in FIG. 5, it is to be appreciated that in one exemplary arrangement, the spaced apart edges include six (6) edges. The second male portion 408 can include magnetic properties for securement to the female receiving end 602 of the torque bit 600. In addition, the second male portion 408 can include a spring biased ball bearing 418 compressible within the female receiving end 602 of the torque bit 600 for increasing the friction between the second male portion 408 and the female receiving end 602.

FIG. 6 illustrates the drill/torque head bit connector 400 in an engaged configuration with a fastener. The plurality of edges 420, 421, 422, 423 are curvilinear along the rounded end and enable canted and angled engagement with the torque bit 600. The angled engagement enables engagement and torquing of the torque bit 600 at a peripheral angle of 360 degrees around the female receiving end 602. The canted engagement enables engagement and torquing of the torque bit 600 at angles ranging from a linear or horizontal orientation (i.e., torque bit axis aligned with fastener axis) to an angle 610 about 50 degrees from the aligned horizontal axis 612.

FIG. 7 illustrates a pair of exemplary torque bits 702, 704 interchangeable with the drill/torque head bit connector 400.

Other shapes, designs, and configurations of the drill/torque head bit connector 100, 400 are contemplated and fall within the scope of the invention without affecting the utility of the device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drill/torque head”, “drill/torque head design”, “detachable drill/torque head”, and “power tools drill head attachment” are interchangeable and refer to the power tools drill head attachment 100, 400 of the present invention.

Notwithstanding the foregoing, the power tools drill head attachment 100, 400 of the present invention can be of any suitable size and configuration as is known in the art without affecting the overall concept of the invention, provided that it accomplishes the above-stated objectives. One of ordinary skill in the art will appreciate that the power tools drill head attachment 100, 400 as shown in the FIGS. are for illustrative purposes only, and that many other sizes and shapes of the power tools drill head attachment 100, 400 are well within the scope of the present disclosure. Although the dimensions of the power tools drill head attachment 100, 400 are important design parameters for user convenience, the power tools drill head attachment 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A torque head bit connector for interchangeably mounting torque bits, the torque head bit connector comprising:
a chuck coupling portion for coupling to a power tool and for receiving power from a drive gear of the power tool;
wherein said chuck coupling portion having a first male portion including a plurality of planar surfaces and a recessed neck for securement in a female chuck of the power tool;
wherein said torque head bit connector is configured to rotate using the drive of the power tool to which said chuck coupling portion is selectively attached;
a torque bit coupling portion having a second male portion for selectively coupling with various torque bits;
wherein said first male portion and said second male portion are at opposing ends of said torque head bit connector;
wherein said torque bits having a female receiving end for connecting with said second male portion; and
further wherein said female receiving end and said second male portion can include a shape comprising a star shape configuration or a rounded shape configuration.

2. The torque head bit connector of claim 1, wherein said torque head bit connector having hex sided shanks.

3. The torque head bit connector of claim 2, wherein said second male portion is magnetic.

4. The torque head bit connector of claim 3, wherein said female receiving end of said torque bit is magnetic.

5. The torque head bit connector of claim 4, wherein said second male portion having a spring biased ball bearing compressible within said female receiving end of said torque bit.

6. The torque head bit connector of claim 1 wherein said rounded shape configuration having a plurality of spaced apart edges.

7. The torque head bit connector of claim 6, wherein said spaced apart edges are curvilinear.

8. The torque head bit connector of claim 7, wherein said spaced apart edges include six edges.

9. The torque head bit connector of claim 8, wherein said torque head bit connector canted at an angle from 30 degrees to 50 degrees from an aligned axis between said torque bit and a fastener.

10. A torque head bit connector for interchangeably mounting torque bits, the torque head bit connector comprising:
a torque head bit connector having a chuck coupling portion for coupling to a power tool and for receiving power from a drive gear of the power tool;
wherein said chuck coupling portion having a first male portion including a plurality of planar surfaces and a recessed neck for securement in a female chuck of the power tool;
wherein said torque head bit connector is configured to rotate using the drive of the power tool to which said chuck coupling portion is selectively attached;
a torque bit coupling portion having a second male portion for selectively coupling with various torque bits;
wherein said first male portion and said second male portion are at opposing ends of said torque head bit connector;
wherein said torque bits having a female receiving end for connecting with said second male portion;
wherein said second male portion can include a shape comprising a generally rounded shape configuration;
wherein said rounded shape configuration having a plurality of spaced apart edges;
wherein said spaced apart edges are curvilinear; and
further wherein said torque head bit connector canted at an angle from 30 degrees to 50 degrees from an aligned axis between said torque bit and a fastener.

11. The torque head bit connector of claim 10, wherein said torque head bit connector having hex sided shanks.

12. The torque head bit connector of claim 11, wherein said second male portion is magnetic.

13. The torque head bit connector of claim 12, wherein said female receiving end of said torque bit is magnetic.

14. The torque head bit connector of claim 13, wherein said second male portion having a spring biased ball bearing compressible within said female receiving end of said torque bit.

15. The torque head bit connector of claim 14, wherein said spaced apart edges include six edges.

16. A torque head bit connector for interchangeably mounting torque bits, the torque head bit connector comprising:
a chuck coupling portion for coupling to a power tool and for receiving power from a drive gear of the power tool;
wherein said chuck coupling portion having a first male portion including a plurality of planar surfaces and a recessed neck for securement in a female chuck of the power tool;
wherein said torque head bit connector is configured to rotate using the drive of the power tool to which said chuck coupling portion is selectively attached;
a torque bit coupling portion having a second male portion for selectively coupling with various torque bits;
wherein said first male portion and said second male portion are at opposing ends of said torque head bit connector;
wherein said torque bits having a female receiving end for connecting with said second male portion;
wherein said second male portion can include a shape comprising a generally rounded shape configuration;
wherein said rounded shape configuration having a plurality of spaced apart edges;
wherein said spaced apart edges are curvilinear;
wherein said torque head bit connector canted at an angle from 30 degrees to 50 degrees from an aligned axis between said torque bit and a fastener; and
further wherein said second male portion having a spring biased ball bearing compressible within said female receiving end of said torque bit.

17. The torque head bit connector of claim 16, wherein said torque head bit connector having hex sided shanks.

18. The torque head bit connector of claim 17, wherein said second male portion is magnetic.

19. The torque head bit connector of claim 18, wherein said female receiving end of said torque bit is magnetic.

20. The torque head bit connector of claim 19, wherein said spaced apart edges include six edges.
